(19) United States
(12) Patent Application Publication
(10) Pub. No.: US 2015/0332203 A1
(43) Pub. Date: Nov. 19, 2015

(54) System for Remote Management of Residential Property Service Providers and Property Managers

(71) Applicant: Mark Anthony Johnson, Newark, OH (US)

(72) Inventor: Mark Anthony Johnson, Newark, OH (US)

(21) Appl. No.: 14/280,773

(22) Filed: May 19, 2014

(51) Int. Cl. G06Q 10/06; G06Q 50/16

(52) U.S. Cl. CPC G06Q 10/063114; G06Q 50/16

(57) ABSTRACT

System and method for remote selection and management of projects by residential property managers and third party vendor service providers. The system provides for a digital means of combining the project selection, project management, and payment aspects of the residential service industry into a single method. The included payment system ensures payment within a set period by automatically triggering payment if it is not triggered by the user after a certain deadline.

### CROSS-REFERENCE TO RELATED APPLICATIONS

Not Applicable

### STATEMENT REGARDING FEDERALLY SPONSORED RESEARCH

Not applicable.

### COPYRIGHT NOTIFICATION

Portions of this patent application may contain materials that are subject to copyright protection. The copyright owner has no objection to the facsimile reproduction by anyone of the patent document, or the patent disclosure, as it appears in the U.S. Patent and Trademark Office.

### BACKGROUND

The residential real estate industry is populated by many small entities. Properties are controlled by property managers or landlords, who can manage from one to two properties up to several hundred properties. Each property that a property manager controls requires continual basic maintenance, with such maintenance projects often being unscheduled or unplanned. Property managers must employ lawn care services, plumbers, and other maintenance specialists to address issues that arise at a tenant's property. Also, whenever a tenant vacates a property, a manager must employ cleaners and painters to prepare the property for the next tenant, frequently on short notice. Many of the service providers with whom a manager deals are independent entities, so a property manager regularly deals with new and different agencies, based on availability and the urgency of maintenance issues. All of the various types of service providers referenced above are grouped in the industry as “vendors.” A vendor in this industry is any party that makes a service available to customers for a cost. Customers are often property managers, but can also be landlords, tenants or any other party that employs a vendor for services related to a residential property.

Though property managers must deal with many different vendors, managers want the work to be performed consistently. Different managers have different standards for the work they request, with some demanding impeccable work, while others are more lenient. As the necessary projects are often spur of the moment, it can be difficult for a property manager to properly communicate his or her personal demands to a vendor. This difficulty in communication can lead to sub-par results, and can create conflict between managers and vendors.

Some managers attempt to convey their requirements and personal preferences for a job by providing their vendors with checklists for the projects. The use of a traditional checklist, however, has several flaws that can lead to a result that is not satisfactory to the property manager. Managers often must rely on a standard checklist, as it is time consuming for a manager to create a new list for each project. However, it is also common for a manager to have special requests for certain projects, so the difficulty of updating lists can make it problematic for a manager to communicate the importance of special requests. There is also often no way for a property manager to confirm that a vendor is following the provided checklist. Property managers who manage many properties do not have time to personally inspect each project. Thus, while a traditional checklist can be a good guideline for a vendor, a property manager may not realize that certain requests were not completed until it is too late to correct them.

The traditional communication system can also pose problems for vendors. Vendors have an incentive to perform projects to the specifications of the property manager, because it increases the likelihood that they will be hired again. However, as vendors often must complete several different projects in a single day to be profitable, they cannot wait for confirmation from a property manager that the project was effectively completed. Without the possibility of real-time critiques from the property manager, vendors may be forced to leave a job site without performing simple touch-ups that the property manager would have requested had he or she been able to view the project's progress.

The residential real estate market could benefit from a system that allows for real-time communications of available jobs, as well as easily updated project task lists. A system that opens up communications between property managers and vendors would alleviate several of the problems stated above, and would help ensure that a property manager's job requests are completed, while also allowing vendors to better understand and complete the assignments for which they are hired.

### BRIEF SUMMARY

The present disclosure relates to a system and method for remote management of job services by residential property managers and third party service providers, otherwise known as vendors. The disclosure provides for a system that integrates itemized checklists, photos, videos, real-time communication and a payment system to allow for efficient and cost-effective completion of tasks by the service providers. The system is made up of several modules whose methods combine to form the final system.

The system begins with a module that allows for the creation of project postings by residential property managers or other parties seeking to hire third party vendors. The parties may post the projects to a database that is viewable by all vendors who subscribe to the system. The vendors can place bids on projects, and are linked to the original poster by the system once a bid is accepted.

The system helps to improve efficiency in the industry by providing property managers with the ability to create customized checklists related to each project created through the system. The checklists are conveyed to the vendors, who can update the checklists and send progress updates to the property managers in real-time. The system allows the vendors to take photos and videos of the project, and send them to the property managers to confirm completion of the tasks on the checklist.

The system integrates the project approval and payment processes through its modules. When a vendor completes a project, it must be approved by the party who posted the project. The property manager can approve the project and initiate payment to the vendor, can reject the project outright, or can approve the project conditioned upon the completion of certain corrections or touch-ups. The system improves on standard payment practices, however, by providing only a certain window within which the approval process can occur. If the property manager fails to approve or reject a project through the system within a certain period of time, payment is automatically initiated to the vendor. Throughout the system a dialogue function will be available for the parties involved in the respective projects, to allow for the exchange of questions or comments between parties. After a project has been finally completed and approved, the system will provide the opportunity for a property manager to give a rating to the vendor based on its project performance, as well as to leave any relevant comments. These ratings and comments will be linked to a vendor's individual profile in the system and will aid in highlighting vendors that commonly provide both effective and ineffective services.

The system is designed to improve efficiency and reduce costs in the industry through the use of a singular system that incorporates several typically separate tasks. The creation of a single bidding pool will better allow both property managers and vendors to contract for necessary projects, and the availability of real-time communication throughout the project process will reduce mistakes in communication that can lead to unnecessarily poor results. The use of customized checklists in the system will allow property managers to better convey their personal preferences for projects, and will better allow vendors to tailor their work to best satisfy the contracting party. The system's payment module is designed to ensure that vendors have their work quickly approved and receive prompt payment. The use of an automatic payment countdown will encourage property managers to quickly evaluate projects for approval, which will allow for both property managers and vendors to more quickly take on further projects.

### BRIEF DESCRIPTION OF THE DRAWINGS

For a fuller understanding of the nature and advantages of the present invention, reference should be had to the following detailed description taken in connection with the accompanying drawings, in which:

FIG. 1 illustrates the general configuration of the system components;

FIG. 2A is a block diagram making up a general representation of the series of modules that make up the system.

FIG. 2B is a block diagram depicting the job selection module of the system;

FIG. 3 is a block diagram depicting the module used for creating and sharing a custom task list as part of the system;

FIG. 4 is a block diagram depicting the process of project completion by vendor service providers using the system;

FIG. 5 is a block diagram depicting the operation of the approval module of the system through which a vendor service provider submits its project to a property manager for approval; and

FIG. 6 is a block diagram depicting the operation of the payment module of the system through which payment to the vendor service provider is triggered after the project has been completed.

### DETAILED DESCRIPTION

Disclosed herein is a combined job selection, job monitoring, and payment system. The preferred use of the system is in the field of residential real estate and property management. The system is designed to address several communication and quality control problems that commonly arise in the residential real estate industry, as well as other industries that regularly deal with contractors and subcontractors. The system integrates several modules that are typically involved in a work relationship between a real estate property manager and a residential service provider, known in the industry as a vendor. The integration of the modules into a single system will serve to reduce time and costs for both property managers and vendors.

The system will allow the property manager and the vendor to complete several typically independent tasks through a single digital interface. The system can be made for use with an individual's personal computer, mobile phone, or other digital device with an internet or other communication connection as is known to those skilled in the art. Such additional communication connections include Bluetooth networks, private wireless networks (i.e. WiFi networks), private networks, virtual private networks, and the like. By way of example, through an internet connection, the parties utilizing the system will be able to communicate in real time, as well as share relevant media, such as photos or videos of work progress. In a preferred embodiment, the system and its operation through the administrative apparatus is made available to users via a portable electronic device, over the internet, or by telephone. In some situations a dedicated communication terminal can be used to enter task completion data, for instance at residential hotel complexes or assisted living centers.

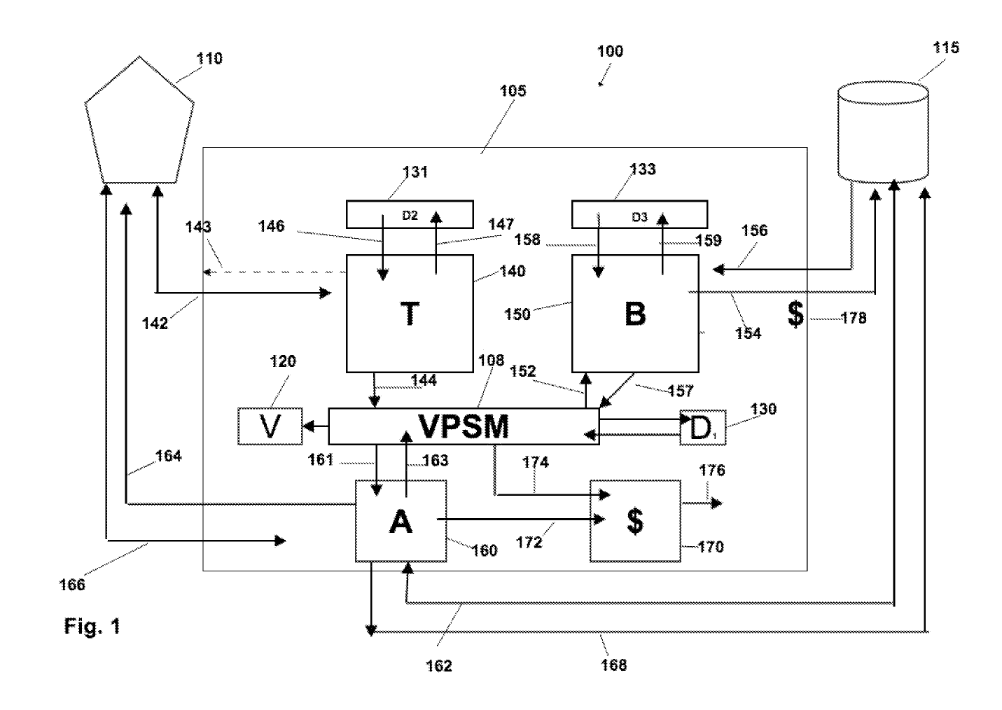

The complete system is made up of several functional modules that each comprise a number of steps and available options for the parties utilizing the system. An illustration of the general architecture of a generic embodiment of the system and its component modules is shown in FIG. 1.

In general, the disclosed system is embodied for providing enhanced management of vendor service provider task performance at residential properties, such as during property tenant turnover or sale. The system provides an automated task administrative apparatus allowing property managers requesting particularized services to indicate task requests. In general, property managers subscribing to the system will expect to require a relatively finite set of tasks, necessary to prepare a property for rental to new tenants, or for preparing for sale or viewing. Included is an administrative task module for providing a selectable task agenda prepopulated with optional task requests. The system may provide for an agenda or menu of fillable additional task requests comprising tasks to be completed at a managed property.

A given property manager, subscribing to the system, completes a task agenda by selecting or filling task requests to be performed and completed by a vendor. The property manager may not have a preference which of available vendors complete the task agenda, or may wish to have only one or more selected vendors complete the job.

Once a task agenda is loaded and activated on the system, a vendor assignment module is invoked that configures the administrative apparatus to deliver a notice of an available task agenda to selected vendors. The vendors can select task agendas they wish to complete, and indicate so using the vendor bidding module, whereupon the system receives indication of acceptance of the task agenda by one or more assigned vendors. The administrative apparatus delivers the task agenda to the assigned vendor, and a list of completion criteria.

A task completion module is provided that displays the task agenda and parameters required for completion of a selected task by the vendor. The task completion module may require a completion entry satisfying the completion criteria to the task completion module, with said completion entry comprising an indicator of task completion, such as a photograph, a numeric indicator or the like.

Once the vendor submits a completed task agenda for approval and payment the system facilitates delivery of the completed task agenda to the property manager upon entry of the completion entry for a selectable number of tasks on the task agenda. This step can be configured to invoke a payment module that delivers a payment to the vendor upon one or more of expiration of a payment countdown, acceptance of the completed task agenda by the property manger, or acceptance of completion by the administrator,

Thus, the present system allows for the property manger to select the task agenda, delivers the task agenda for acceptance to vendors, the task agenda is accepted by the one or more vendors participating in the projects, said vendors then complete the task agenda and provide an indication of completion of the task by entry of the requested completion criteria in the completion module, whereupon the completed task agenda, along with the completion entry is delivered via the administrative apparatus to the property manager, said property manager either accepting the successful task completion, allowing the payment countdown to expire, or rejecting the task completion, where if the task completion is accepted or expires, payment is delivered by the administrative apparatus to the vendor, or the rejection indication and renewed completion criteria are delivered to the vendor.

A further understanding of the operation of the system can be gained by reference to the figures and description that follow.

As shown in FIG. 1, the basic structure of the automated system, 100, for managing the allocation of vendor resources for task performance is shown. Block 105 is the system, including a vendor service provider management module, 108, i.e. VSPM module. In the operation of the disclosed system, the VSPM module is in communication with service requesting property managers, 110, vendors 115, the vendor function manager, 120, and various databases, including database D2, 131, accessible by the property manager, and databases D1 and D2 (130, 133, respectively) controlled by the vendor function managers who contract with the vendors. In essence, property managers act as subscribers to the system to request and receive property services.

The core of the system is embodied in the operation of the vendor function managers, 120 through the VPSM module 108. Vendor function managers, in a preferred embodiment, are human agents monitoring, maintaining and operating the vendor service provider management system herein described. It should be recognized that in alternative embodiments, vendor function managers could be configured as a computer script, a human-machine-software application cooperative effort, or merely a machine algorithm. The vendor function managers represent the administrator for the system, managing the interaction between property managers and vendors.

Vendor service providers, 115, act as registered users of the system, filing a system registration, which if confirmed, allows vendors to be assigned service task jobs made available by property managers, to confirm task performance, and following approval through the VSPM system, to receive payment for services rendered. Vendors provide requested building services, either as an actual worker, or as an agency employing or contracting labor needed to perform the requested tasks.

Block 110 represents one or more property managers who may seek to utilize vendor service providers assignable through the VPSM system. Property managers at block 110 are subscribers to the VPSM system who from time to time request the performance of a variety of tasks in relation to their managed properties. Alternatively, certain property managers may be occasional or single occasion users of the VPSM system, and request performance of a routine task set.

It is a great advantage of the present system, and an advantage previously not available, that the vendor manager and the requesting property managers are able to dynamically alter control parameters, for instance task price, bid availability, and special task features. A wide variety of variables may be regulated through the setting of control parameters by either the VPSM administrator, or by a requesting property manager. Examples of control parameters envisioned by the disclosure include payment history both for property managers and service providers; task completion rating for vendors; experience rating for vendors; and task performance time, for instance.

Contained within block 105, the VPSM module is comprised of a number of interacting subsystems: the VPSM control module, 108, a task module, 140, an assignment and bidding module 150, a submission and approval module 160, and a payment module, 170. VPSM control module 108 comprises a control system that interacts with and integrates information from property managers 110 through the task module 140 and from registered vendor service providers 115, through the assignment module 150. The VPSM control module also integrates data transferred to and from the approval module 160 and payment module 170. These various modules, i.e. subsystems, are in communication either directly, or indirectly with databases, including databases D1-D3 (130, 131, 133).

A property manager wishing to contract for vendor service can initiate contact with the VPSM system, for instance through the task module 140. For example, a requesting user administrator 115 may contact a responding provider administrator 110 on an occasion when the customer service resources of the requesting user are insufficient to handle requests for customer service contacts, i.e. calls from the customer pool 120. The requesting property manager 110 logs into the VPSM system through the task module, and either recalls a preset task list, or creates a new task list on database D2 131. These task requests are logged into the task module 140 and confirmation returned to the property manager, 110 as shown by arrows 142 and 166. These task requests are then delivered through arrow 144 to the VPSM control module, which integrates the task list to match a set of available vendor service providers using assignment parameters. Once those control parameters have successfully determined the available service providers, the information is delivered to the assignment/bidding module 150 via arrow 144 and the VPSM control module 108 through arrow 152.

The assignment/bidding module publishes available assignments to selected vendors. Announcement of available tasks to the vendors 115 is through arrow 154. Vendors can accept a job bid through arrow 156, accept other available tasks, or await more a favorable job/task assignment. Once a task is accepted by a vendor, the assignment/bidding module notifies the VPSM control module through arrow 157, which then updates the available task requests published on the assignment/bidding module 150. The assignment/bidding module may utilize a resident database, as at D3 133, or other available databases, such as D1 at 130.

The assigned vendor service provider then is tasked to complete the task list by the deadline indicated by the bidding module. Intermediate completion milestones may also be indicated/requested. To indicate completion of tasks, the vendors interact with the approval module 160. The approval module can be queried by the vendor, delivering information, shown as arrow 162, i.e. task completion verification requirements, received through and managed by the VPSM module using information from the task module (through arrow 144) delivered to the task module by the property manager 110. Such information could be in the form of, for instance, a printed task list, an electronic application interface on a data network connected mobile computing device, a video, or GPS location information. Through the VPSM module, both the property manager and the vendor are able to monitor the task progress through the VPSM system. As shown by arrows 163 and 164, the approval module may make available information useful in monitoring the work of the contracted vendors.

After submission of a project for approval by a vendor, i.e. though arrow 162, the approval request is delivered via arrow 164 to the property manager. The property manager can request additional work, or approve the project through arrow 166. If additional work is indicated, the requested task list is delivered to the vendor via arrow 168. Both submission for approval and approval can be monitored by the VPSM control module. In another embodiment, upon submission, the project is indicated for payment by the expiration of an approval clock, or by indicated approval from the property manager, as at arrow 166. If approved, the approval module delivers a task completion indication via arrow 172 to the payment module 170. Once payment is approved by the vendor administrator, by way of arrow 174, the payment module delivers payment to a payment recipient 178 as indicated by arrow 176. Alternatively, if the approval clock expires prior to receipt of an indication from the property manager, payment can be automatically triggered, such as by way of arrow 174.

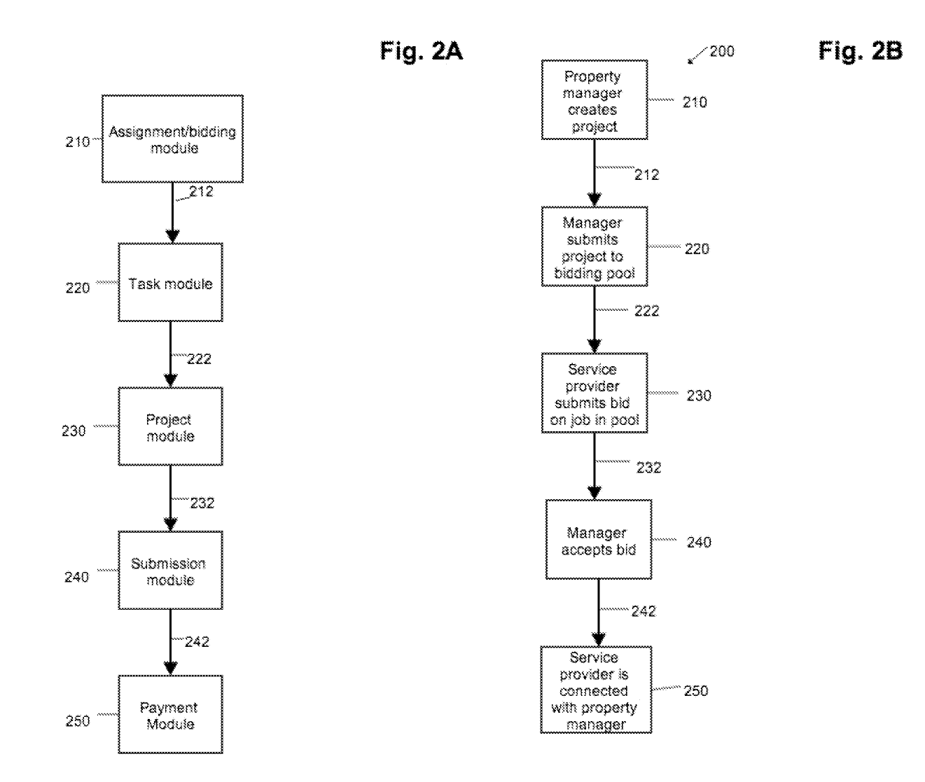

FIG. 2A shows a flow chart of the process of a project being assigned to a particular vendor service provider. The system begins with the assignment/bidding module, at block 210, through which a service provider accepts a project made available by a property manager or landlord. The task module, as at block 220 follows, wherein the task module allows the property manager subscriber to choose, create or update a list of task requirements for a particular project. Working from the task list requirements received through the task module, the project 230 guides the work of the service provider, and allows the service provider to update the project status as work is completed, as well as allowing the parties, including the property manager, the vendor service manager to exchange communications regarding the project. The submission module 240 provides a system for the service provider to submit a completed project to a vendor manager for final approval, and allows for either the property manager or the system to approve the completed project or to request additional work. Finally, the payment module 250, following approval, provides a system for ensuring prompt payment to the vendor. In a preferred embodiment, the payments are delivered by the vendor administrator, who handles and accounts for billing and payments from the property managers.

FIG. 2B represents a detailed representation of the assignment/bidding module as indicated at block 210. The bidding process will take place through the VPSM system's digital interface. All parties wishing to utilize the system's resources, including both property managers and vendors, will typically need to create an individual profile for use within the system. The creation of unique profiles will allow the property managers and vendor service providers participating in a project to be easily linked or matched to one another and to exchange communications regarding the project. Property managers who wish to hire a vendor may post available projects from their individual profiles, and vendors can seek to be hired for a project by submitting a request using their own profile. The module begins when a property manager or other party seeking to hire a vendor service provider creates a project posting using the system 260. The system will allow the property manager to create a unique posting based on personal preferences, but can also provide the property manager with templates of one or more common projects, to simplify and streamline the project creation step. Once the project is created, the property manager submits the project to the bidding pool 220. The bidding pool is a database of all currently posted projects available for bidding by vendors. An available project remains in the bidding pool until a bid has been accepted, or it is removed by the poster. A vendor may submit bids on projects available in the bidding pool 230. The poster of the project then accepts a bid 240 on the project out of bids made by vendors. Once a bid has been accepted the system establishes a link between the vendor service provider and the poster of the project 250.

In a preferred embodiment, the property manager can make a particular project available to a subset of the entire registered bidding pool, using various selection parameters, including previous performance parameters.

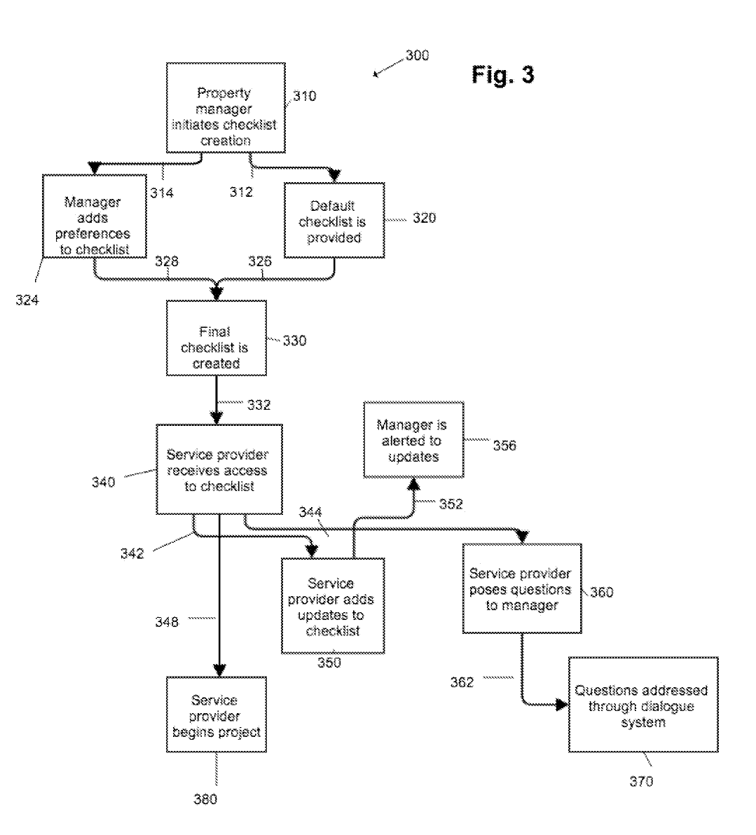

FIG. 3 represents a likely embodiment of the task list module 300 of the system. The task list module allows the property manager or other party who has retained the vendor to create a shared checklist of tasks necessary for successful completion of the project. The task list will be available in digital form through the system, and both parties can be allowed to update the list. The property manager creates the task list 310 after he or she has been linked to the vendor. The system will provide a number of default checklists 320 tailored for common projects, and will also allow the property manager to add his or her own preferences or requirements for a project 324 to a task list. The ability to easily request certain tasks allows managers to better ensure that their projects will be completed to their liking. The final task listing is created 330 by combining any utilized default checklist with tasks added by the manager 326, 328.

After the manager indicates that the task list has been finalized 332 a digital version of the list is made available to the vendor via the system 340. The vendor may be able to add its own updates to the checklist 350, at the discretion of the property manager. Whenever an update to the task list is created by the vendor, the system will send a notification to the property manager 356 of the changes. The system will also provide a dialogue system that will become available to a project poster and vendor service provider once the two have been linked on a particular project. If the vendor has any comments or questions regarding the checklist 360, it may pose a question or request clarification through the dialogue system. The property manager may respond to these questions 370 by using the dialogue system as well. After the vendor is has finalized the task list, it begins work on the project 380 and the system transitions into the next module.

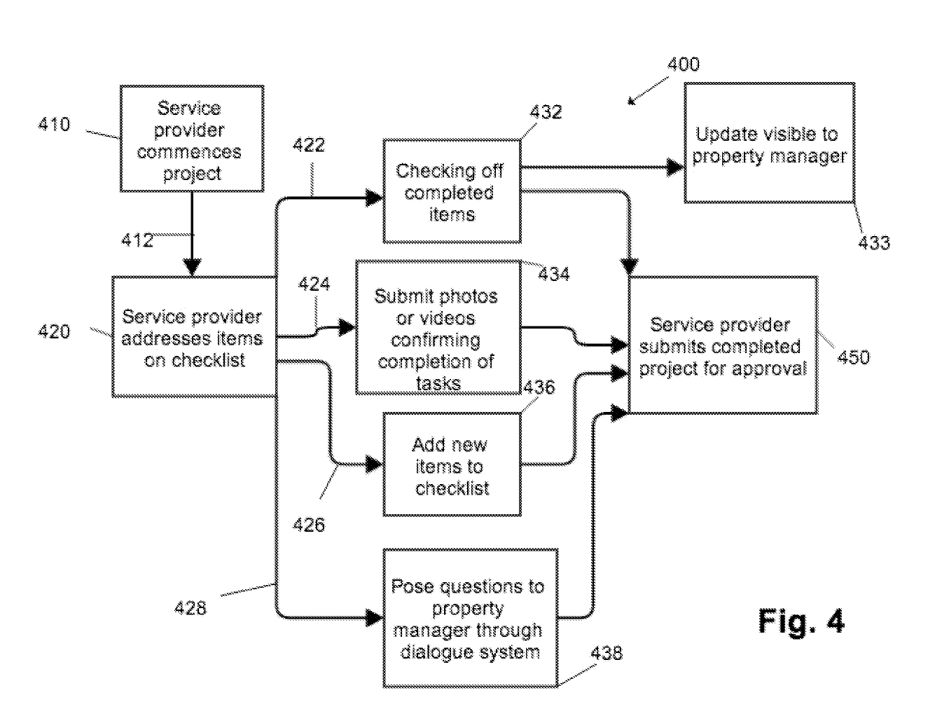

FIG. 4 depicts the project module. The module 400 begins once the vendor service provider starts work on the project. The vendor can ensure that it is performing the project up to the standards of the property manager by addressing the items provided on the task list 420. Once a task is completed, the vendor can check off each task as completed 432 on the task list by utilizing the system's digital interface. The progress on the tasks is constantly visible to the property manager 433, and each time a task is checked by the vendor, the property manager can see that the task has been completed.

The vendor service provider can also take several other actions while completing a project. The system allows the vendor to submit photos or videos 434 to the property manager, showing the progress of the project. In a preferred embodiment the system provides for a property manager to require that photo or video evidence be submitted for certain tasks or for all tasks. The vendor may also add new tasks to the checklist 426 as the project progresses. As in the previous module, all newly added tasks immediately become visible to the property manager. The vendor is able to continually pose questions 438 or request clarifications through the dialogue system. When the vendor has completed all tasks on the task list, it submits the completed project to the property manager for final approval 450.

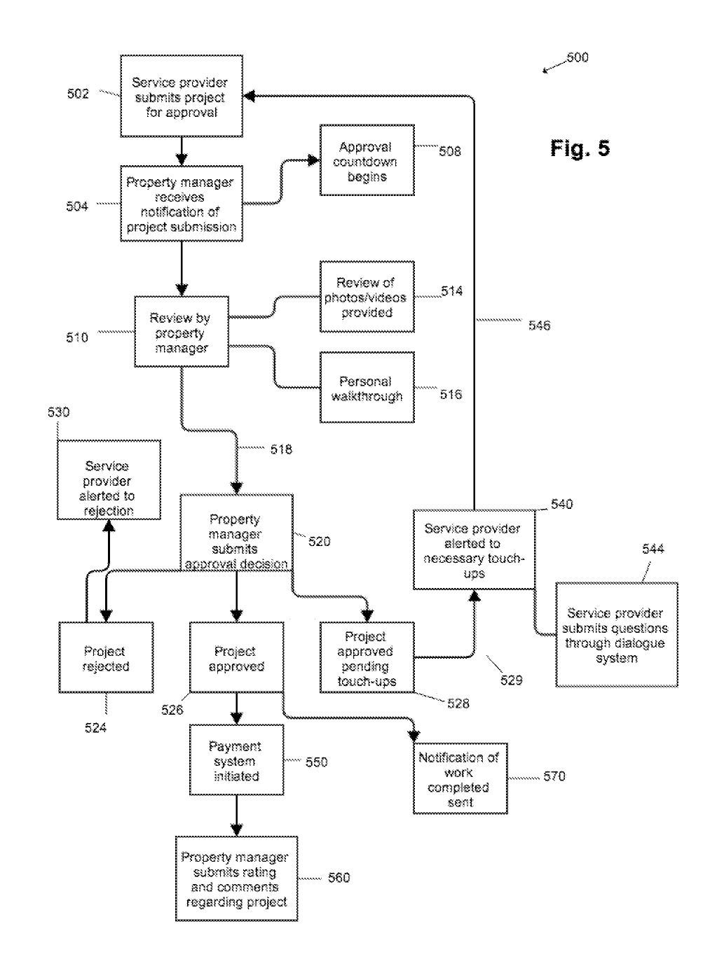

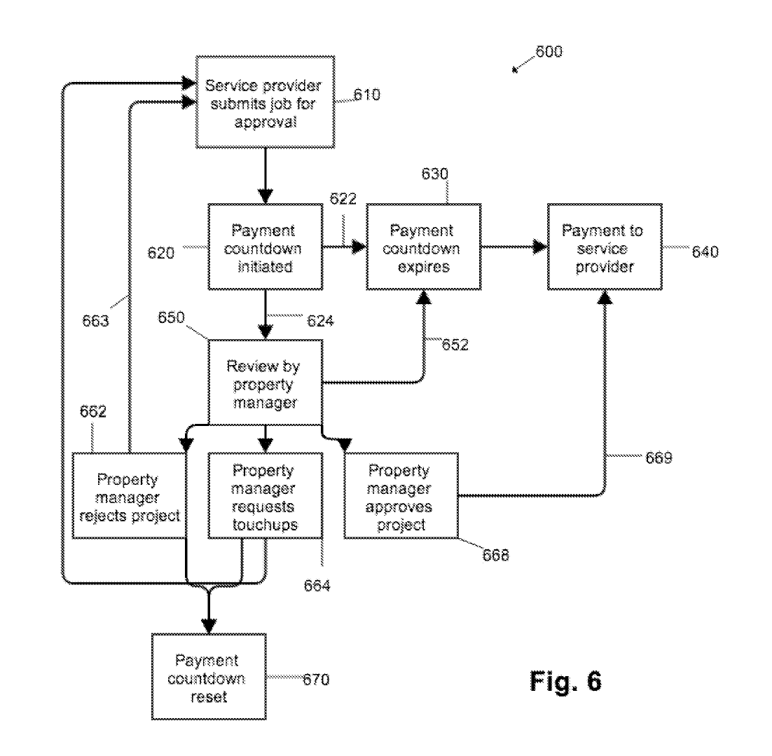

A preferred embodiment of the VPSM system is to manage the vendor service provider task completion. FIG. 5 depicts the process of submitting a completed project for final approval. The submission module 500 begins when the vendor submits a project for final approval 502. After submission, the system provides the property manager with all evidence of the project 504 that was compiled by the vendor. This includes the completed checklist, any photos or videos taken, and any final comments on the project submitted by the vendor. Alternatively, the completion evidence can be provided after entry at particularized project milestones. When the property manager has received notification of final submission, the countdown for final approval and payment begins 508 (see FIG. 6).

The system is configurable to implement the use of service applications on mobile electronic devices, i.e., software apps, to enable vendor service providers to communicate with the property manager while on the job-site by means of uploading pictures, messaging through the dialogue system, or by relaying information updates and questions to the administrator, the property manager, or both, depending on the system configuration and the option of the subscriber and administrator.

A novel embodiment of the present system is the availability of a number of different data submissions to demonstrate successful or thorough completion of assigned tasks. Such data may be photographs, submitted to the system electronically; scanning of locator bar codes; entry of text or serial number codes; quiz-type entry requirements, i.e., “indicate the brand of the shower fixture;” or written description of the steps taken to complete the task. Those skilled in the art of property management will recognize a number of additional data indicators that can be used to confirm task completion.

In an alternative embodiment, activateable bar codes, images or the like, can be applied to discrete or hidden locations on fixtures to be cleaned according to the task list. For instance, pressure sensitive, heat sensitive, or water sensitive stickers (labels) could be applied to the underside of certain fixtures, such as bathroom fixtures. Upon cleaning of the fixture, the label is activated by the action of the vendor during cleaning. Thereupon, the vendor service provider can scan or photograph the activated label, and upload the completion evidence using a portable electronic communications device.

Before final approval is made by the property manager, he or she will review the project 510. This review can involve reviewing only the task list and provided photos and videos 514, or can be done through an in person review 516 of the project area. As many property managers employ several vendors each day to complete various projects, it is often impossible for a manager to ensure that each project receives a thorough in-person review. After the review by the property manager, the property manager submits a decision on approval of the project 520. The property manager can approve the project 526, completely reject the project 524, or approve the project pending the completion of touch-ups or corrections 528.

If the project is rejected 524, the vendor is immediately provided with a notification 530 that the project has not been approved. The next stage after rejection is at the discretion of the property manager. The property manager may seek to employ another vendor to complete the project, or may allow the original vendor to attempt the project again. If the property manager requests touch-ups before final approval 528, the property manager must list the requested touch-ups, which are sent to the vendor 529. When the property manager submits his or her decision, the vendor receives a notification that approval is contingent on completing the listed touch-ups 540. The vendor can submit any questions regarding the touch-ups to the property manager through the dialogue system 544. The vendor then completes the requested touch-ups 546, and can provide photos and videos of the progress as in the project module. When the touch-ups are completed, the vendor service provider submits the touch-ups for approval 502, and the process of the module begins again.

After final approval of the project 526, the payment system is triggered 550. The system also allows for the property manager to request that a notification regarding the completion of the project be sent to another party after approval 570. The notification can be sent through the system, or the system can generate an electronic mail file to be sent to a party. This can be used for purposes such as alerting a new tenant that the residence has been cleaned prior to move-in. The notification can include the completed task list, as well as any photo or video evidence of the project. Once the property manager has approved the project, the system will request that he or she submit a rating and comments 560 regarding the project and the vendor. These ratings and comments will be linked to the service provider's individual profile, and can be viewed by property managers during the bidding module on future projects.

In another embodiment of the system, during the approval process, the property manager again enters a rating for the vendor service provider. This rating can be used to evaluate a vendor for accessing future project bidding, for adjusting the bid offer price, or the like. In certain circumstances, the property manager is required to enter a completion rating for the vendor. In particular this requirement may be invoked for new property managers, or for vendors with limited experience with the system, with a particular property, or with a particular property manager. The system can be implanted to utilize the completion rating to determine the availability of task agendas to a given vendor service provider, for instance.

FIG. 6 depicts a breakdown of the payment module 600. The module is triggered when the vendor service provider submits the project for final approval 610. Thus, the module becomes active even before final approval is made by the property manager. The moment the vendor submits the project for approval, a payment countdown is initiated 620. The payment countdown will be regulated by the system, and will last for a given time, 48 hours for example, which can be adjusted based on the type of project. The property manager has only the time given by the payment countdown 622 to make a decision on approval of the project. If the payment countdown expires prior to an approval decision 630, payment is automatically made to the vendor through the system 640. This feature reassures participating vendor service providers that they will be paid promptly, and prevents a lengthy approval decision by a property manager from delaying payment to a vendor.

The property manager has the time given by the payment countdown to perform his or her review of the project 650. As shown in FIG. 5, the property manager may reject the project 662, request touchups on the project 664, or approve the project 668. If the property manager rejects a project or requests touch-ups, the payment countdown is stopped and reset 670. If the project is rejected 662, based on the dealings between the property manager and vendor 663, the vendor may be able to resubmit the project for approval 610, at which time the payment countdown will begin again 620. If the property manager requests touch-ups prior to final approval 664, the vendor must perform the touch-ups and resubmit the project 610. The payment countdown then begins again 620 after the touch-ups are submitted. If the property manager makes a final approval of the project 668 prior to the expiration of the payment countdown, payment is immediately made to the vendor service provider 640.

While the invention has been described with reference to preferred embodiments, those skilled in the art will understand that various changes may be made and equivalents may be substituted for elements thereof without departing from the scope of the invention. In addition, many modifications may be made to adapt a particular situation or material to the teachings of the disclosure without departing from the essential scope thereof. All terms not specifically defined herein are considered to be defined according to Webster's New Twentieth Century Dictionary Unabridged, Second Edition. The disclosures of all of the citations provided are being expressly incorporated herein by reference. The disclosed invention advances the state of the art and its many advantages include those described and claimed.

1. A system configured for providing enhanced management of service provider task performance comprising
a) an automated task administrative apparatus allowing requesting property managers to indicate task requests;
b) a task module for providing one or more selectable task agendas to be completed at a managed property;
c) a property manager completing a task agenda by selecting or filling task requests for performance and completion by a service provider;
d) a service provider assignment module that configures the administrative apparatus to deliver a notice of an available task agenda to selected service providers, and then receive indication of acceptance of the task agenda by one or more assigned service providers;
e) the administrative apparatus delivering the task agenda to the assigned service provider;
f) a task completion module that displays the task agenda and parameters required for completion of a selected task by the service provider, further comprising a completion entry satisfying the completion criteria to the task completion module, said completion entry comprising an indicator of task completion;
g) delivery of a completed task agenda to the property manager upon entry of the completion entry for a selectable number of tasks on the task agenda; and
h) a payment module that delivers a payment to the service provider upon one or more of expiration of a payment countdown, acceptance of the completed task agenda by the property manger, or acceptance of completion by the administrator,
whereby, the property manger selects the task agenda, delivers it for acceptance to service providers, the task agenda is accepted by one or more service providers, said service providers then complete the task agenda, and provide an indication of completion of the task by entry of the requested completion criteria in the submission module, whereupon the completed task agenda, along with the completion entry is delivered via the administrative apparatus to the property manager, said property manager either accepting the successful task completion, allowing the payment countdown to expire, or rejecting the task completion, where if the task completion is accepted or expires, payment is delivered by the administrative apparatus to the service provider account, or the rejection indication and renewed completion criteria are delivered to the service provider.

2. The system of claim 1 wherein the administrative apparatus is made available to users via a portable electronic device, over the internet, or by telephone.

3. The system of claim 1 wherein the property manager is required to enter a completion rating for the service provider.

4. The system of claim 3 wherein the completion rating is appended to the system profile of a given service provider and accessible to property managers.

5. The system of claim 4 wherein the service provider completion rating is accessed by the assignment module to select a set of qualified service providers in response to indicated preferences of the property manager thereby publishing the availability of task agendas to the qualified service providers consistent with the preferences of the property manager.

6. The system of claim 1 further comprising the use of service applications on mobile electronic devices to enable service providers to communicate with the property manager while on the job-site, by means of uploading pictures, messaging through the administrative system, or relaying information, updates, and questions.

7. The system of claim 1 wherein the completion entry is comprised of evidence that can only be obtained for submission with the completion entry by the following successful completion of the task by the vendor.

8. The system of claim 7 further comprising the completion entry comprising one or more of activated bar codes, activated images, evidence located in hidden positions, wherein the completion entry is available following successful task completion.

9. The system of claim 8 further comprising an activated bar code activated by one or more of heat, pressure, or water contact.

10. The system of claim 1 further comprising a task module for providing a task agenda wherein the selectable task agenda provides one or more task agendas prepopulated with optional task requests that may be selected for inclusion in the task agenda or optional task requests and a text modifiable set of additional task requests for inclusion in a selected task agenda, whereupon selection of optional task requests, or entry of text into text modifiable task requests are included in the task agenda.

11. The system of claim 1 wherein the automated administrative task apparatus further comprises an internet accessible computing system with hardware memory operating the system.

12. A system configured for providing enhanced management of service provider task performance comprising
a) an automated task administrative apparatus allowing requesting property managers to indicate task requests, the automated administrative task apparatus further comprising an internet accessible computing system with hardware memory operating the system;
b) a task module for providing one or more selectable task agendas to be completed at a managed property, said task module further comprising a component of the task module for providing a task agenda wherein the selectable task agenda provides one or more task agendas prepopulated with optional task requests that may be selected for inclusion in the task agenda or optional task requests and a text modifiable set of additional task requests for inclusion in a selected task agenda, whereupon selection of optional task requests, or entry of text into text modifiable task requests are included in the task agenda;
c) a property manager completing a task agenda by selecting or filling task requests for performance and completion by a service provider;
d) a service provider assignment module that configures the administrative apparatus to deliver a notice of an available task agenda to selected service providers, and then receive indication of acceptance of the task agenda by one or more assigned service providers;
e) the administrative apparatus delivering the task agenda to the assigned service provider;
f) a task completion module that displays the task agenda and parameters required for completion of a selected task by the service provider, further comprising a completion entry satisfying the completion criteria to the task completion module, said completion entry comprising an indicator of task completion;
g) delivery of a completed task agenda to the property manager upon entry of the completion entry for a selectable number of tasks on the task agenda; and
h) a payment module that delivers a payment to the service provider upon one or more of expiration of a payment countdown, acceptance of the completed task agenda by the property manger, or acceptance of completion by the administrator,
whereby, the property manger selects the task agenda, delivers it for acceptance to service providers, the task agenda is accepted by one or more service providers, said service providers then complete the task agenda, and provide an indication of completion of the task by entry of the requested completion criteria in the completion module, whereupon the completed task agenda, along with the completion entry is delivered via the administrative apparatus to the property manager, said property manager either accepting the successful task completion, allowing the payment countdown to expire, or rejecting the task completion, where if the task completion is accepted or expires, payment is delivered by the administrative apparatus to the service provider account, or the rejection indication and renewed completion criteria are delivered to the service provider.

13. The system of claim 12 wherein the property manager is required to enter a completion rating for the service provider.

14. The system of claim 13 wherein the completion rating is appended to the system profile of a given service provider and accessible to property managers, wherein the service provider completion rating is accessed by the assignment module to select a set of qualified service providers in response to indicated preferences of the property manager thereby publishing the availability of task agendas to the qualified service providers consistent with the preferences of the property manager.

15. The system of claim 12 wherein the completion entry is comprised of evidence that can only be obtained for submission with the completion entry by the following successful completion of the task by the vendor.

16. A method for providing enhanced management of service provider task performance comprising
a) an automated task administrative apparatus allowing requesting property managers to indicate task requests, the automated administrative task apparatus further comprising a network accessible computing system with hardware memory operating the system;
b) a task module for providing one or more selectable task agendas to be completed at a managed property, said task module further comprising a component of the task module for providing a task agenda wherein the selectable task agenda provides one or more task agendas prepopulated with optional task requests that may be selected for inclusion in the task agenda or optional task requests and a text modifiable set of additional task requests for inclusion in a selected task agenda, whereupon selection of optional task requests, or entry of text into text modifiable task requests are included in the task agenda;
c) a property manager completing a task agenda by selecting or filling task requests for performance and completion by a service provider;
d) a service provider assignment module that configures the administrative apparatus to deliver a notice of an available task agenda to selected service providers, and then receive indication of acceptance of the task agenda by one or more assigned service providers;
e) the administrative apparatus delivering the task agenda to the assigned service provider;
f) a task completion module that displays the task agenda and parameters required for completion of a selected task by the service provider, further comprising a completion entry satisfying the completion criteria to the task completion module, said completion entry comprising an indicator of task completion;
g) delivery of a completed task agenda to the property manager upon entry of the completion entry for a selectable number of tasks on the task agenda; and
h) a payment module that delivers a payment to the service provider upon one or more of expiration of a payment countdown, acceptance of the completed task agenda by the property manger, or acceptance of completion by the administrator,
whereby, the property manager accesses the computing system comprising the automated administrative task apparatus over the network, and selects the task agenda, delivers it for acceptance to service providers, the task agenda is accepted by one or more service providers, said service providers then complete the task agenda, and provide an indication of completion of the task by entry of the requested completion criteria in the completion module, whereupon the completed task agenda, along with the completion entry is delivered via the administrative apparatus to the property manager, said property manager either accepting the successful task completion, allowing the payment countdown to expire, or rejecting the task completion, where if the task completion is accepted or expires, payment is delivered by the administrative apparatus to the service provider account, or the rejection indication and renewed completion criteria are delivered to the service provider.

17. The method of claim 16 wherein the property manager enters a completion rating for the service provider, the completion rating being appended to a composite system profile of a given service provider accessible to property managers.

18. The method of claim 17 wherein the service provider completion rating is accessed through the assignment module by the property manger to select a set of qualified service providers in response to indicated preferences of the property manager thereby publishing the availability of task agendas to the qualified service providers consistent with the preferences of the property manager.

19. The method of claim 16 wherein the completion entry is comprised of evidence that can only be obtained for submission with the completion entry by the following successful completion of the task by the vendor.

20. The method of claim 16 further comprising the use of service applications on mobile electronic devices to enable service providers to communicate with the property manager while on the job-site, by communicating through the automated administrative task apparatus thereby uploading pictures, messaging through the administrative system, or relaying information updates, and questions.
